(19) United States
(12) Patent Application Publication
(10) Pub. No.: US 2005/0232318 A1
(43) Pub. Date: Oct. 20, 2005

(54) Laser amplifier

(75) Inventors: Junji Kawanaka, Kyoto (JP); Masayuki Fujita, Osaka (JP); Yasukazu Izawa, Osaka (JP)

Correspondence Address: BANNER & WITCOFF, 1001 G STREET N W, SUITE 1100, WASHINGTON, DC, 20001, US

(73) Assignee: Japan Atomic Energy Research Institute, Kashiwa-shi (JP)

(21) Appl. No.: 11/037,465

(22) Filed: Jan. 19, 2005

(30) Foreign Application Priority Data
Jan. 20, 2004 (JP) 11482/2004

(51) Int. Cl. H01S 3/04

(52) U.S. Cl. 372/35; 372/34

(57) ABSTRACT

A method and an apparatus capable of efficient laser amplification by cooling a semiconductor laser pumped, ytterbium doped YAG crystal to a temperature between 8 K and 230 K.

### BACKGROUND OF THE INVENTION

This invention relates to the technology of high-efficiency laser light generation in a solid-state laser apparatus of a type to be pumped with a semiconductor laser.

The semiconductor laser pumped solid-state laser includes an amplifying portion composed of a solid-state lasing material that is pumped with a semiconductor laser and which has considerable effects on the characteristics of the laser apparatus. An Yb:YAG laser which is a typical semiconductor laser pumped solid-state laser uses a YAG crystal as a solid-state material after it is doped with ytterbium as an optically active medium. The amplifying operation of a lasing material may be evaluated by slope efficiency which represents the ratio of an increment of output energy to an increment of pumping energy during laser oscillation. One of the major advantages of the Yb:YAG laser is that the theoretical limit of its slope efficiency can be increased to as high as about 90%. However, if a semiconductor laser is used as a pumping source, the theoretical limit of the slope efficiency is only about 60%. As a solution to this problem, an attempt has been made to perform cryogenic cooling of an Yb doped YAG crystal (Yb³⁺:Y₃Al₅O₁₂) but without any higher slope efficiency.

According to A. Giesen, H. Hugel, A. Voss, K. Wittig, U. Brauch, H. Opower, “Scalable concept for diode-pumped high-power solid-state lasers”, Applied Physics B (Springer-Verlag), Vol. 58, pp. 365-372 (1994), an Yb doped YAG crystal was used to perform laser oscillation at a crystal temperature of 100 K-340 K. In this process, laser oscillation characteristics for 100 K were exhibited to give a slope efficiency of 85%. However, in order to achieve high-intensity pumping, a Ti:sapphire laser capable of producing high beam quality was used as a pumping light source and a semiconductor laser was not used (the latter being unable to realize higher pumping intensity since it produces only low beam quality and involves difficulty in focusing light).

According to T. Kasamatsu, H. Sekita and Y. Kuwano, “Temperature dependence and optimization of 970 nm diode-pumped Yb:YAG and Yb:LuAG lasers”, Applied Optics (Optical Society of America, OSA), Vol. 38, No. 24, pp. 5149-5153 (Aug. 20, 1999), an Yb doped YAG crystal was used to perform laser oscillation at a crystal temperature of 80 K-310 K with a semiconductor laser being used as a pumping source (maximum pumping intensity: 7 kW/cm²). With an optimum crystal temperature being set to 160 K, the slope efficiency was about 60% but this was only comparable to the value obtained at room temperature.

Further, according to J. Kawanaka, K. Yamakawa, H. Nishioka and K. Ueda, “Improved high-field laser characteristics of a diode-pumped Ya:LiYF₄ crystal at low temperature”, Optics Express (Optical Society of America, OSA), Vol. 10, No. 10, pp. 445-460 (May 20, 2002), an Yb doped YLF (Yb³⁺:LiYF₄) crystal was used to produce oscillation characteristics under cryogenic condition (77 K). In that study, a semiconductor laser was used as a pumping light source but an Yb doped YAG crystal was not used.

One of the major advantages of the Yb:YAG laser is that the theoretical limit of its slope efficiency as defined above can be increased to as high as about 90%. However, if a semiconductor laser is used as a pumping light source, the theoretical limit that can actually be obtained is no more than about 60%. With such great optical loss in the lasing crystal, efficient laser amplification is yet to be achieved.

### SUMMARY OF THE INVENTION

An object, therefore, of the present invention is to provide an amplifier that can perform efficient lasing operation even if it is pumped with comparatively low intensity as by a semiconductor laser.

The present inventor made intensive studies in order to attain the stated object and postulated that since the optical loss in the Yb doped YAG crystal decreased while the laser gain increased at low temperature, these effects could be combined synergistically to achieve remarkable improvement in the performance of laser amplification. This provided a basis for the invention of a laser amplifier characterized by cooling a Yb doped solid-state lasing material to a low temperature between 8 K and 230 K, preferably between 8 K and 100 K.

Optical loss decreases at low temperature since the light absorbing wavelength of ytterbium which contributes to optical loss shifts from the wavelength of laser amplified light, whereupon ytterbium no longer absorbs the laser light. Laser gain increases at low temperature for the following reason: if a semiconductor laser of an appropriate wavelength is chosen, the absorbance of the pumping light it emits is sufficiently increased at the low temperature that ytterbium which is also an optically active medium becomes more optically active.

According to the present invention, efficient lasing operation is assured even if pumping is performed with comparatively low intensity as by a semiconductor laser and, hence, a laser can be realized that is compact and can be pumped with a semiconductor laser to operate stably. The efficient operation offers another advantage: the heat generation from the lasing material which leads to energy loss is sufficiently suppressed that the laser is stable even if it is operated to produce high average output.

### BRIEF DESCRIPTION OF THE DRAWINGS

FIG. 1 shows diagrammatically an example of the laser amplifier of the invention;

FIG. 2 shows diagrammatically an exemplary oscillator that uses the laser amplifier of the invention; and

FIG. 3 is a graph showing the laser output energy from the oscillator shown in FIG. 2 vs. the pumping energy from the semiconductor laser also shown in FIG. 2.

### DETAILED DESCRIPTION OF THE INVENTION

The present invention is characterized in that the slope efficiency and the energy conversion efficiency are both high, with typical values being 90% and 75%, respectively.

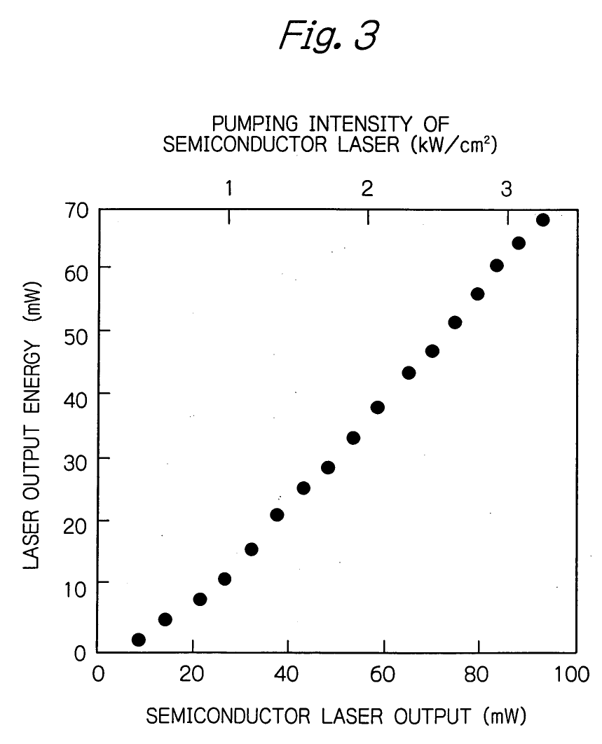

Various kinds of optical loss occur in the laser oscillator and amplifier, as exemplified by the loss in the resonator, the reflection loss from the crystal surface and the absorption loss of the crystal itself, and laser oscillation or amplification is materialized only when such diverse optical loss is more than compensated by the optical gain of the lasing medium. The optical gain of the lasing medium increases with the pumping energy and as FIG. 3 shows, the pumping energy may be increased from zero until it reaches a certain level (threshold energy), whereupon laser oscillation or amplification takes place.

The energy conversion efficiency is the ratio of newly produced laser light (output energy) to input excitation light (pumping energy), so it represents the overall conversion efficiency of the laser system inclusive of optical loss. Therefore, other than the laser amplifying portion (lasing material), optical loss is also a factor that significantly influences the energy conversion efficiency. In the case of the amplifier, except in special situations, optical loss in the laser system is small, so the threshold is low and the energy conversion efficiency may be considered almost equal to the slope efficiency. However, in the case of the oscillator, the optical loss in such components as the resonator is far greater than that in the amplifier, so the above equation does not generally hold.

On the other hand, slope efficiency is the ratio of an increment of output energy to an increment of input energy after laser oscillation or amplification. Since the two increments are compared in a region where optical gain has exceeded optical loss, slope efficiency can evaluate the characteristics of the lasing material per se independently of optical loss.

Therefore, in order to realize an efficient method of amplification, higher slope efficiency is more important whereas in order to materialize an efficient oscillator, higher energy conversion efficiency is more important.

### EXAMPLE

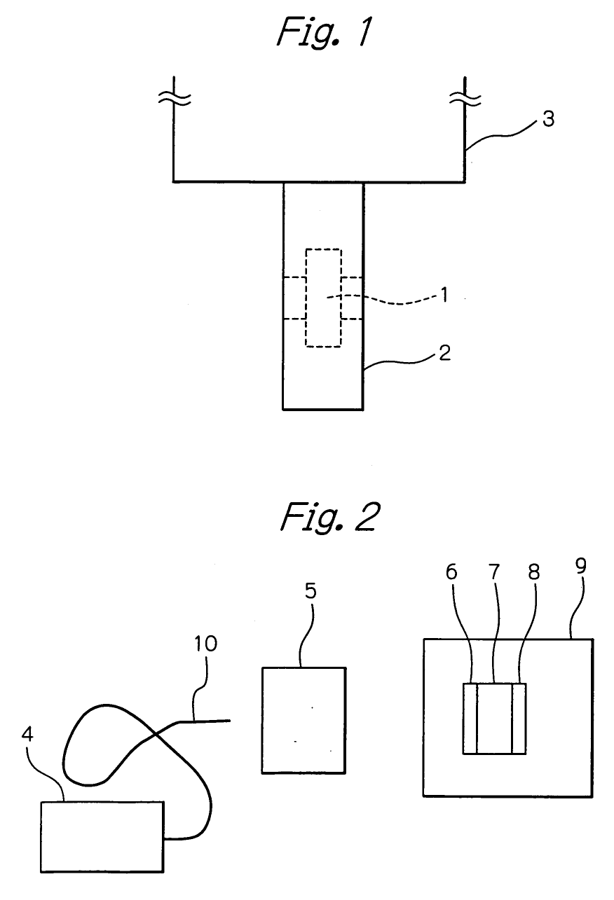

FIGS. 1 and 2 show a specific example of the laser amplifier of the present invention which is generally indicated by 7 in FIG. 2. The lasing material was an Yb:YAG crystal 1 with a dopant concentration of 20 at % in the form of a thin disk measuring 5 mm×5 mm×2 mm. The two 5 mm×5 mm faces of the crystal were polished by laser ablation. The crystal was sandwiched between two copper plates 2 each having a thickness of 2 mm. A hole with a diameter of 3 mm was made through each copper plate to ensure the passage of laser light through the centers of the two polished faces of the crystal.

The copper plates were mounted as a lasing material holder on a cooling section 3 within a vacuum chamber 9 in a cryogenic apparatus. The copper plates could be controlled at any temperature between 10 K and 300 K. Thus, the laser amplifier 7 was composed of the Yb:YAG crystal 1, the two Cu plates 2 holding the crystal 1 between them, and the Cu plate cooling section 3. Needless to say, this is not the sole construction of the present invention and various embodiments are possible for details about the lasing material and its holder, such as structure, setup, shape and size.

FIG. 2 shows a specific example of a laser oscillator employing the present invention. The Yb:YAG crystal 1 in the laser amplifier 7 shown in FIG. 1 was cooked to 100 K. A laser resonator was composed of two resonator mirrors 6 and 8 placed on opposite sides of the amplifier 7. One of the resonator mirrors would transmit the pumping wavelength of a semiconductor laser 4 (910-944 nm) but reflect the laser emission wavelength (1030 nm) with high efficiency. The other resonator mirror was used as a coupling mirror that would transmit a portion of the laser emission wavelength.

The Yb:YAG crystal and the resonator mirrors were both placed within the vacuum chamber 9 in the cryogenic apparatus. The pumping laser light from the semiconductor laser 4 capable of fiber output was focused on the Yb:YAG crystal from outside the cryogenic apparatus by being guided through a light condensing optical system 5. The semiconductor laser capable of fiber output is designed as a package in which the laser output was guided through the light condensing optical system and the like to an end of fiber optics and picked up from the other end. This package design, which enables the laser light pickup end to be placed in a desired area, is commercially available. The wavelength of the semiconductor laser may range from 910 nm to 944 nm, preferably at 940 nm.

Thus, laser oscillation became possible and as FIG. 3 shows, the already noted performance values, slope efficiency of 90% and energy conversion efficiency of 75% (at a pumping intensity of 3.2 kW/cm²) were obtained when the Yb:YAG crystal was cooled to 100 K and below.

It is therefore clear from FIG. 3 that according to the present invention, efficient laser operation (laser output) is possible even if pumping is done with comparatively low intensity as by a semiconductor laser.

1. A laser amplifier which enables highly efficient laser amplification by cryogenic cooling of a semiconductor laser pumped, ytterbium doped YAG crystal (Yb³⁺:Y₃AlO₁₂).

2. A method of highly efficient laser amplification which comprises cooling a semiconductor laser pumped, ytterbium doped YAG crystal to a temperature between 8 K and 230 K, preferably between 8 K and 100 K.

3. A laser oscillator which employs the laser amplifier according to claim 1 and a laser resonator comprising two resonator mirrors placed on opposite sides of the laser amplifier.

4. A laser amplifier which enables highly efficient laser amplification by cryogenic cooling of an ytterbium doped YAG crystal that has been pumped with a semiconductor laser having fiber output.

5. A method of highly efficient laser amplification which comprises cooling an ytterbium doped YAG crystal that has been pumped with a semiconductor laser to a temperature between 8 K and 230 K, preferably between 8 K and 100 K.

6. A laser oscillator which employs the laser amplifier according to claim 4 and a laser resonator comprising two resonator mirrors placed on opposite sides of the laser amplifier.

7. A laser generator comprising a semiconductor laser, fiber optics for guiding the light from the semiconductor laser, an optical system for condensing the light from the semiconductor laser as it emerges from the fiber optics, and a solid-state laser oscillator that is to be pumped with the condensed light from the semiconductor laser, wherein said laser oscillator comprises a laser amplifier composed of an ytterbium doped YAG crystal and two resonator mirrors placed on opposite sides of the laser amplifier, said crystal is cooled to between 8 K and 230 K, preferably between 8 K and 100 K, so as to reduce the optical loss in the crystal but increase the laser gain, thereby producing synergism to enhance the laser amplifying performance of the crystal.
